(19) United States
(12) Patent Application Publication
(10) Pub. No.: US 2009/0269601 A1
(43) Pub. Date: Oct. 29, 2009

(54) Norbornene Compound Addition Polymer, Process for Producing the Same, Molded Article Comprised of the Polymer, and Use Thereof

(75) Inventors: Atsushi Ishiguro, Tokyo (JP); Shingo Okuno, Tokyo (JP); Yasuo Tsunogae, Tokyo (JP)

Correspondence Address: BIRCH STEWART KOLASCH & BIRCH, PO BOX 747, FALLS CHURCH, VA, 22040-0747, US

(73) Assignee: Zeon Corporation, Tokyo (JP)

(21) Appl. No.: 11/992,307

(22) PCT Filed: Aug. 28, 2006
(86) PCT No.: PCT/JP2006/316840

§ 371 Date: Jul. 16, 2008

(30) Foreign Application Priority Data
Sep. 22, 2005 (JP) 2005 275826
Dec. 22, 2005 (JP) 2005 369362

(51) Int. Cl. B32B 27/28; C08F 30/04; C08F 4/80

(52) U.S. Cl. 428/500; 526/241; 526/108

(57) ABSTRACT

[PROBLEMS] To provide: a norbornene compound addition polymer which has excellent heat resistance and suffers no decrease in the excellent transparency and mechanical properties even when exposed to high temperatures during molding, processing, or use; and a process for producing the polymer.

[MEANS FOR SOLVING PROBLEMS] The norbornene compound addition polymer comprises, as an essential ingredient, repeating structural units derived from a substituted norbornene compound monomer, wherein the total content of atoms of the transition metals in Group 10 of the Periodic Table, halogen atoms, phosphorus atoms, aluminum atoms, boron atoms, and sulfur atoms is 50 wt. ppm or lower. The process for producing a norbornene compound addition polymer comprises bringing a norbornene compound addition polymer comprising, as an essential ingredient, repeating structural units derived from a substituted norbornene compound monomer into contact with an ion-exchanging lamellar inorganic compound.

### TECHNICAL FIELD

The present invention relates to a norbornene compound addition polymer that has a small content of a heat deterioration-accelerating substance, a process for producing the same, a molded article comprised of the polymer, and use thereof. More specifically, it relates to a norbornene compound addition polymer that suffers from no deterioration in transparency and mechanical properties even under a high temperature environment, a process for producing the same, a molded article comprised of the same, and use thereof.

### BACKGROUND ART

There are increasing demands for weight reduction, size reduction and densification in optical materials including an optical member, such as a lens and the like, a display substrate for a liquid crystal display device, an EL display device and the like, a backlight, a light guide plate and the like. However, inorganic glass, which has been used in this field, has such disadvantages of breakability, lack of flexibility, a large specific gravity, poor workability, and the like. Accordingly, it has been investigated to substitute inorganic glass with a transparent resin.

Upon using a resin in the field of optical materials, considerably high performances are demanded in heat resistance, chemical resistance, low water-absorbing property and the like, in addition to transparency. For example, in the case where a resin is used as a material for a substrate of a display device, it is demanded not to suffer from heat deformation or decrease in transparency due to coloration upon processing at a high temperature in a step of laminating a metal or metal oxide thin film.

However, an acrylate resin and a polycarbonate resin, which have been used as an optical material, have insufficient heat resistance and low water-absorbing property and cannot be used practically.

Under the circumstances, a norbornene compound addition polymer has been proposed as a resin that can satisfy heat resistance, chemical resistance, low water-absorbing property and optical properties, and it has been proposed to use the polymer as an optical material, such as a material for a liquid crystal substrate (Patent Documents 1 and 2).

A norbornene compound addition polymer generally has a high glass transition temperature (Tg) of 250° C. or higher and thus is a material that is excellent in resistance to heat deformation upon processing at a high temperature. However, it has a problem that coloration occurs due to heat deterioration at a high temperature by a polymerization catalyst remaining in the polymer causing decrease in transparency.

One of possible measures for solving the problem caused by the polymerization catalyst is to remove the polymerization catalyst residue from the polymer.

Based on the concept, there have been tried methods for removing the polymerization catalyst residue; a method of rinsing with an acidic aqueous solution or the like; a method of adsorbing with an adsorbent; a method of using an ion exchange resin; a method of adding a chelate compound to form a chelate compound, which is then filtered; and a method of solidifying with a poor solvent (for example, Patent Documents 3, 4 and 5), but the polymerization catalyst residue has not yet been removed to such an extent that causes no problem of coloration and decrease in transparency.

Another possible measure is to decrease the amount of the catalyst used for polymerization.

Non-patent Document 1 discloses that unsubstituted norbornene can be polymerized using an extremely small amount of a catalyst. However, a homopolymer of unsubstituted norbornene is a polymer that is insoluble in a common solvent and thus has a problem that it cannot be molded into a sheet and a film.

Patent Document 6 reports that a transparent film can be produced without a catalyst-removing step by using a polymerization catalyst having extremely high activity. However, the film has a problem that it suffers from coloration and considerable decrease in mechanical strength, even when exposed to a high temperature of 200° C. or higher.

Accordingly, such a norbornene compound addition polymer has not yet been known that can withstand molding and processing under a high temperature environment and has high transparency and mechanical properties.

Patent Document 1: JP-A-5-61026 (U.S. Pat. No. 5,334,424)
Patent Document 2: JP-A-2002-114826 (U.S. Pat. No. 6,639,021)

### Patent Document 3: JP-A-2005-48060

### Patent Document 4: JP-A-2005-126514

### Patent Document 5: JP-A-2004-307603

### Patent Document 6: International Patent Publication

### Non-patent Document 1: Organometallics, 2001, vol. 20, p. 2802

### DISCLOSURE OF THE INVENTION

### Problems to be Solved by the Invention

Accordingly, the object of the invention is to provide a norbornene compound addition polymer that is excellent in heat resistance and suffers from no decrease in excellent transparency and mechanical properties thereof upon exposing to a high temperature upon molding, processing and using, a process for producing the same, a molded article comprised of the same, and use thereof.

### Means for Solving the Problems

As a result of earnest investigations made by the inventors for attaining the object, it has been found that impurities, such as a polymerization catalyst residue, can be efficiently removed from a norbornene compound addition polymer by treating a solution of the norbornene compound addition polymer with a specific compound, and it has been also found that the resulting norbornene compound addition polymer containing an extremely small amount of the polymerization catalyst residue, particularly a halogen atom and a phosphorus atom, is excellent in heat resistance and can maintain excellent transparency and mechanical strength even when exposed to a high temperature. Thus, the invention has been completed based on the findings.

The invention provides a norbornene compound addition polymer that comprises, as an essential component, a repeating structural unit derived from a norbornene compound monomer having a substituent and has a total content of a transition metal atom of Group 10 of Periodic Table, a halogen atom, a phosphorus atom, an aluminum atom, a boron atom and a sulfur atom of 50 ppm by weight or less.

The norbornene compound addition polymer of the invention preferably has a content of a halogen atom of 30 ppm by weight or less.

Preferably the norbornene compound addition polymer of the invention has a content of a phosphorus atom of 1 ppm by weight or less.

Preferably the norbornene compound addition polymer of the invention is one obtained by polymerization with a catalyst comprising, as essential components, a transition metal atom of Group 10 of Periodic Table, a halogen atom and a phosphorus atom.

More preferably the norbornene compound addition polymer of the invention is one obtained by polymerization with a catalyst comprising, as essential components, palladium, a halogen atom and a phosphorus atom.

The invention provides a process for producing the norbornene compound addition polymer comprising a step of bringing a norbornene compound addition polymer comprising, as an essential component, a repeating structural unit derived from a norbornene compound monomer having a substituent, into contact with an ion-exchangeable layered inorganic compound in an organic solvent.

In the process for producing a norbornene compound addition polymer, the norbornene compound addition polymer is preferably brought into contact with the ion-exchangeable layered inorganic compound in the organic solvent under a hydrogen atmosphere.

In the process for producing a norbornene compound addition polymer, the ion-exchangeable layered inorganic compound is preferably one containing, as constitutional elements, aluminum and (magnesium and/or iron).

The invention also provides a molded article composed of the norbornene compound addition polymer of the invention.

The molded article of the invention may have a form of a sheet or film.

The molded article of the invention may have a form of a sheet or film having a transparent electroconductive film laminated thereon.

The invention further provides a color filter substrate composed of the norbornene compound addition polymer of the invention.

The color filter substrate of the invention may have a form of a sheet or film.

The invention further provides a color filter comprised of the color filter substrate.

The invention further provides an optical member, an electric insulating member, an electric or electronic member, an electronic member sealant, medical equipment or a packaging material comprised of the molded article composed of the norbornene compound addition polymer of the invention.

The invention provides a liquid crystal display device substrate comprised of a sheet or film, composed of the norbornene compound addition polymer of the invention, having or not having a transparent electroconductive film laminated thereon.

The invention also provides a polarizing film comprised of a sheet or film, composed of the norbornene compound addition polymer of the invention and having or not having a transparent electroconductive film laminated thereon, having a polarizing film laminated on at least one surface thereof via or not via an adhesive layer.

The invention also provides a phase retardation film comprised of a sheet or film, composed of the norbornene compound addition polymer of the invention, that has or has not a transparent electroconductive film laminated thereon and has been stretched in at least one direction at a stretching ratio of from 1.1 to 4 times.

### ADVANTAGE OF THE INVENTION

The norbornene compound addition polymer of the invention is excellent in heat resistance and can retain excellent transparency and mechanical properties thereof even when exposed to a high temperature. The norbornene compound addition polymer is useful as a material for a molded article, such as an electric insulating member, an electric or electronic member, an electronic member sealant, medical equipment, a packaging material and the like, in addition to an optical member, such as a substrate for a color filter and the like.

### BEST MODE FOR CARRYING OUT THE INVENTION

### Norbornene Compound Addition Polymer

The norbornene compound addition polymer of the invention comprises, as an essential component, a repeating structural unit represented by the general formula (I).

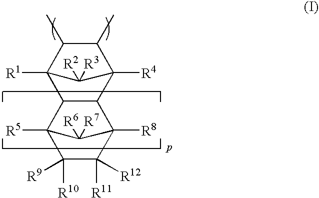

In the general formula (I), R¹ to R¹² each independently represent a hydrogen atom; a functional group containing an oxygen atom, a nitrogen atom or a silicon atom; or a hydrocarbon group having from 1 to 20 carbon atoms, which may have the functional group. All of R¹ to R¹² do not represent hydrogen atoms at the same time. R⁹ to R¹² may be bonded to each other to form a monocyclic ring or a condensed ring. p represents 0 or a positive integer.

p is preferably from 0 to 3, more preferably from 0 to 2, and particularly preferably 0 or 1.

Specific examples of the functional group include a functional group containing an oxygen atom, such as hydroxy, alkoxy, aryloxy, carbonyl, hydroxycarbonyl, alkoxycarbonyl, aryloxycarbonyl, acid anhydride and the like; a functional group containing a nitrogen atom, such as amino, alkylamino, arylamino, cyano and the like; a functional group containing an oxygen atom and a nitrogen atom, such as aminocarbonyl, alkylaminocarbonyl, arylaminocarbonyl and the like; a functional group containing a silicon atom, such as silyl, alkylsilyl, arylsilyl and the like; and a functional group containing a silicon atom and an oxygen atom, such as alkoxysilyl, aryloxysilyl and the like.

The functional group preferably does not contain a halogen atom, a phosphorus atom, an aluminum atom, a boron atom and a sulfur atom.

The hydrocarbon group having from 1 to 20 carbon atoms may be any one of an alkyl group, an alkenyl group or an aryl group.

The content of the repeating structural unit represented by the general formula (I) is preferably from 1 to 99% by mol, and more preferably from 2 to 50% by mol.

The norbornene compound addition polymer of the invention may contain a repeating structural unit represented by the general formula (II), and preferably contains the repeating structural units represented by the general formula (I) and the general formula (II) in an total amount of 70% by mol or more, more preferably 90% by mol or more, further preferably 95% by mol or more, and particularly preferably 100% by mol.

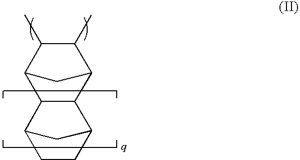

In the general formula (II), q represents 0 or a positive integer.

q is preferably from 0 to 3, more preferably 0 to 2, and particularly preferably 0 or 1.

The norbornene compound addition polymer can be obtained by polymerizing a norbornene compound monomer having a substituent represented by the general formula (III). In this case, a norbornene monomer represented by the general formula (IV) may be copolymerized.

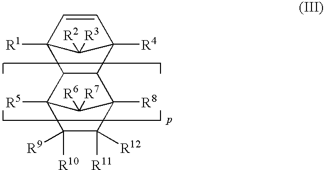

In the general formula (III), R¹ to R¹² and p have the same meanings as in the general formula (I).

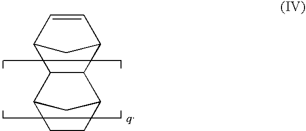

In the general formula (IV), q has the same meaning as in the general formula (II).

The norbornene compound monomer used in the invention may be any one of a bicyclo[2.2.1]hept-2-ene compound of the general formula (III) or (IV) wherein p and q are each 0, and a tetracyclo[6.2.1.1^{3,6}.0^{2,7}]dodec-4-ene compound of the general formula wherein p and q are each 1, and also may be a compound of the general formula wherein p and q are each 2 or more.

Specific examples of the bicyclo[2.2.1]hept-2-ene compound include the following monomers:

2-norbornene (bicyclo[2.2.1]hept-2-ene having no substituent); a bicyclo[2.2.1]hept-2-ene compound having a hydrocarbon substituent, such as 5-methyl-2-norbornene, 5-ethyl-2-norbornene, 5-butyl-2-norbornene, 5-hexyl-2-norbornene, 5-decyl-2-norbornene, 5-cyclohexyl-2-norbornene, 5-cyclopentyl-2-norbornene, 5-ethylidene-2-norbornene, 5-vinyl-2-norbornene, 5-propenyl-2-norbornene, 5-cyclohexenyl-2-norbornene, 5-cyclopentenyl-2-norbornene, 5-phenyl-2-norbornene and the like; a bicyclo[2.2.1]hept-2-ene compound of the general formula (III) wherein R⁹ to R¹² are bonded to each other to form a monocyclic ring or a condensed ring, such as tetracyclo[9.2.1.0^{2,10}.0^{3,8}]tetradeca-3,5,7,12-tetraene (which may be referred to as 1,4-methano-1,4,4a,9a-tetrahydro-9H-fluorene), tetracyclo[10.2.1.0^{2,11}.0^{4,9}]pentadeca-4,6,8,13-tetraene (which may be referred to as 1,4-methano-1,4,4a,9,9a,10-hexahydroanthracene), dicyclopentadiene, methyldicyclopentadiene, dihydrodicyclopentadiene (tricyclo[5.2.1.0^{2,6}]dec-8-ene) and the like;

a bicyclo[2.2.1]hept-2-ene compound having a hydroxycarbonyl group or an acid anhydride group, such as 5-norbornene-2-carboxylic acid, 5-norbornene-2,3-dicarboxylic acid, 5-norbornene-2,3-dicarbocylic anhydride;

a bicyclo[2.2.1]hept-2-ene compound having a hydroxy group, such as 5-hydroxy-2-norbornene, 5-hydroxymethyl-2-norbornene, 5,6-di(hydroxymethyl)-2-norbornene, 5,5-di(hydroxymethyl)-2-norbornene, 5-(2-hydroxyethoxycarbonyl)-2-norbornene, 5-methyl-5-(2-hydroxyethoxycarbonyl)-2-norbornene and the like;

a bicyclo[2.2.1]hept-2-ene compound having an alkoxycarbonyl group, such as methyl 5-norbornene-2-carboxylate, ethyl 5-norbornene-2-carboxylate, methyl 2-methyl-5-norbornene-2-carboxylate, ethyl 2-methyl-5-norbornene-2-carboxylate and the like;

a bicyclo[2.2.1]hept-2-ene compound having a hydrocarbonyl group, such as 5-norbornene-2-carbaldehyde and the like;

a bicyclo[2.2.1]hept-2-ene compound having an alkoxycarbonyl group and a hydroxycarbonyl group, such as 3-methoxycarbonyl-5-norbornene-2-carboxylic acid;

a bicyclo[2.2.1]hept-2-ene compound having a carbonyloxy group, such as 5-norbornen-2-yl acetate, 2-methyl-5-norbornen-2-yl acetate, 5-norbornen-2-yl acrylate, 5-norbornen-2-yl methacrylate and the like;

a bicyclo[2.2.1]hept-2-ene compound having a functional group containing a nitrogen atom, such as 5-norbornene-2-carbonitrile, 5-norbornene-2-carboxamide, 5-norbornene-2,3-dicarboxylic imide and the like; and

a bicyclo[2.2.1]hept-2-ene compound having a functional group containing a silicon atom, such as 5-trimethoxysilyl-2-norbornene, 5-triethoxysilyl-2-norbornene and the like.

Specific examples of the tetracyclo[6.2.1.1^{3,6}.0^{2,7}]dodec-4-ene compound include the following monomers:

tetracyclo[6.2.1.1^{3,6}.0^{2,7}]dodec-4-ene (without a substituent); a tetracyclo[6.2.1.1^{3,6}.0^{2,7}]dodec-4-ene compound having a hydrocarbon group substituent, such as 9-methyltetracyclo[6.2.1.1^{3,6}.0^{2,7}]dodec-4-ene, 9-ethyltetracyclo[6.2.1.1^{3,6}.0^{2,7}]dodec-4-ene, 9-cyclohexyltetracyclo[6.2.1.1^{3,6}.0^{2,7}]dodec-4-ene, 9-cyclopentyltetracyclo[6.2.1.1^{3,6}.0^{2,7}]dodec-4-ene, 9-methylenetetracyclo[6.2.1.1^{3,6}.0^{2,7}]dodec-4-ene, 9-ethylidenetetracyclo[6.2.1.1^{3,6}.0^{2,7}]dodec-4-ene, 9-vinyltetracyclo[6.2.1.1^{3,6}.0^{2,7}]dodec-4-ene, 9-propenyltetracyclo[6.2.1.1^{3,6}.0^{2,7}]dodec-4-ene, 9-cyclohexenyltetracyclo[6.2.1.1^{3,6}.0^{2,7}]dodec-4-ene, 9-cyclopentenyltetracyclo[6.2.1.1^{3,6}.0^{2,7}]dodec-4-ene, 9-phenyltetracyclo[6.2.1.1^{3,6}.0^{2,7}]dodec-4-ene and the like;

a tetracyclo[6.2.1.1^{3,6}.0^{2,7}]dodec-9-ene compound having an alkoxycarbonyl group, such as methyl tetracyclo[6.2.1.1^{3,6}.0^{2,7}]dodec-9-ene-4-carboxylate, methyl 4-methyltetracyclo[6.2.1.1^{3,6}.0^{2,7}]dodec-9-ene-4-carboxylate and the like;

a tetracyclo[6.2.1.1^{3,6}.0^{2,7}]dodec-9-ene compound having a hydroxycarbonyl group or an acid anhydride group, such as tetracyclo[6.2.1.1^{3,6}.0^{2,7}]dodec-9-ene-4-carboxylic acid, tetracyclo[6.2.1.1^{3,6}.0^{2,7}]dodec-9-ene-4,5-dicarboxylic acid, tetracyclo[6.2.1.1^{3,6}.0^{2,7}]dodec-9-ene-4,5-dicarboxylic anhydride and the like;

a tetracyclo[6.2.1.1^{3,6}.0^{2,7}]dodec-9-ene compound having a hydroxy group, such as tetracyclo[6.2.1.1^{3,6}.0^{2,7}]dodec-9-ene-4-methanol, tetracyclo[6.2.1.1^{3,6}.0^{2,7}]dodec-9-en-4-ol and the like;

a tetracyclo[6.2.1.1^{3,6}.0^{2,7}]dodec-9-ene compound having a hydrocarbonyl group, such as tetracyclo[6.2.1.1^{3,6}.0^{2,7}]dodec-9-ene-4-carbaldehyde and the like;

a tetracyclo[6.2.1.1^{3,6}.0^{2,7}]dodec-4-ene compound having a carbonyloxy group, such as 9-tetracyclo[6.2.1.1^{3,6}.0^{2,7}]dodec-4-enyl acetate, 9-tetracyclo[6.2.1.1^{3,6}.0^{2,7}]dodec-4-enyl acrylate, 9-tetracyclo[6.2.1.1^{3,6}.0^{2,7}]dodec-4-enyl methacrylate and the like;

a tetracyclo[6.2.1.1^{3,6}.0^{2,7}]dodec-9-ene compound having a functional group containing a nitrogen atom, such as tetracyclo[6.2.1.1^{3,6}.0^{2,7}]dodec-9-ene-4-carbonitrile, tetracyclo[6.2.1.1^{3,6}.0^{2,7}]dodec-9-ene-4-carboxamide, tetracyclo[6.2.1.1^{3,6}.0^{2,7}]dodec-9-ene-4,5-dicarboxylic imide and the like; and

a tetracyclo[6.2.1.1^{3,6}.0^{2,7}]dodec-9-ene compound having a functional group containing a silicon atom, such as 4-trimethoxysilyltetracyclo[6.2.1.1^{3,6}.0^{2,7}]dodec-9-ene, 4-triethoxysilyltetracyclo[6.2.1.1^{3,6}.0^{2,7}]dodec-9-ene and the like.

The number average molecular weight (Mn) of the norbornene compound addition polymer of the invention is not particularly limited. When the norbornene compound addition polymer is used as a substrate for a color filter, the polystyrene equivalent molecular weight thereof is generally from 10,000 to 500,000, preferably from 20,000 to 450,000, and more preferably from 50,000 to 400,000. In the case where the number average molecular weight (Mn) is too small, the polymer cannot be molded into a substrate due to too poor mechanical properties. In the case where it is too large, on the other hand, it is difficult to mold due to too high a solution viscosity.

The norbornene compound addition polymer of the invention has high heat resistance and has a glass transition temperature of from 200 to 500° C., preferably from 220 to 450° C., and more preferably from 240 to 400° C. According to the feature, the norbornene compound addition polymer of the invention is suitable to a substrate for a color filter.

The norbornene compound addition polymer of the invention can be obtained by polymerizing one or more kinds of norbornene compound monomers containing, as an essential component, the norbornene compound monomer represented by the general formula (III) in the presence of a polymerization catalyst.

The polymerization catalyst is not particularly limited, and preferred examples thereof include a polymerization catalyst comprising a Group 10 transition metal catalyst, for example, a polymerization catalyst containing palladium, phosphorus and a halogen atom, such as [6-methoxynorbornen-2-yl-5-palladium (cycloctadiene)]hexafluorophosphate disclosed in JP-T-11-505880 (WO96/37526) and the like; a polymerization catalyst containing palladium, phosphorus and a halogen atom and boron, such as (allyl)palladium chloride dimer/tricyclohexylphosphine/lithium tetrakis(pentafluorophenyl)borate 2.5 ether disclosed in WO2000/20472 and the like; a polymerization catalyst containing palladium, phosphorus and a halogen atom and aluminum, such as (phenyl)palladium bis(triphenylphosphine) iodide/methylaluminoxane disclosed in JP-A-2001-098035 and the like; and the like.

The polymerization catalysts contain a Group 10 transition metal atom and a halogen atom as essential components, preferably contain a phosphorus atom for further enhancing the polymerization activity, and, in some cases, contain at least one selected from the group consisting of an aluminum atom, a boron atom and a sulfur atom.

In the invention, such a catalyst system is particularly preferred that contains, as essential components, palladium as a Group 10 transition metal atom and a halogen atom, further contains a phosphorus atom, and contains, in some cases, at least one selected from the group consisting of an aluminum atom, a boron atom and a sulfur atom.

In some cases, the norbornene compound addition polymer obtained in the aforementioned manner contains an olefinic unsaturated bond, and a polymer obtained by hydrogenating the olefinic unsaturated bond is also encompassed within the norbornene compound addition polymer of the invention.

The hydrogenation reaction may be carried out by an ordinarily known method, i.e., by contact with hydrogen in the presence of a hydrogenation catalyst. Examples of the hydrogenation catalyst used include a solid catalyst comprising a Groups 8 to 10 transition metal atom such as nickel, palladium, platinum, cobalt, ruthenium, rhodium or the like, or a compound thereof supported on a porous carrier such as carbon, alumina, silica, silica-alumina, diatomite or the like, and a uniform catalyst of an organic carboxylate salt of a Groups 4 to 10 metal, such as cobalt, nickel, palladium and the like, a combination of a β-diketone compound with an organoaluminum compound or an organolithium compound, and a complex of ruthenium, rhodium, iridium or the like.

The norbornene compound addition polymer after polymerization or after hydrogenation reaction contains at least a Group 10 transition metal atom and a halogen atom as a residue of the polymerization catalyst, the hydrogenation catalyst and a co-catalyst thereof, and contains at least one selected from the group consisting of a phosphorus atom, an aluminum atom, a boron atom and a sulfur atom depending on the kind of the catalyst.

In the norbornene compound addition polymer of the invention, the total content of a Group 10 transition metal atom in the Periodic Table, a halogen atom, a phosphorus atom, an aluminum atom, a boron atom and a sulfur atom is 50 ppm by weight or less, preferably 40 ppm by weight or less, more preferably 30 ppm by weight or less, and particularly preferably 10 ppm by weight or less, based on the weight of the polymer.

In the case where the total amount of a Group 10 transition metal atom in the Periodic Table, a halogen atom, a phosphorus atom, an aluminum atom, a boron atom and a sulfur atom contained in the polymer is too large, the polymer may suffer from yellowing at a high temperature, and a sheet or film thereof may suffer from cracking.

In the norbornene compound addition polymer of the invention, the content of a halogen atom is preferably 30 ppm by weight or less, and more particularly preferably 10 ppm by weight or less, based on the polymer.

In the norbornene compound addition polymer of the invention, the content of a phosphorus atom is preferably 1 ppm by weight or less based on the polymer.

### (Process for Producing Norbornene Compound Addition Polymer)

The norbornene compound addition polymer of the invention containing a small amount of impurities such as Group 10 transition metal atom in the Periodic Table and the like, can be obtained by bringing a norbornene compound addition polymer into contact with an ion-exchangeable layered inorganic compound in an organic solvent.

The ion-exchangeable layered inorganic compound is a compound having a crystalline structure where sheet structures constituted of atoms or atomic groups through ionic bonds or the like are laminated in parallel with each other through weak force and ions contained therein are exchangeable. The major components of the ion-exchangeable layered inorganic compound are silicic acid, alumina and water, and may further contain Fe, Mg, Ca, Na, K and the like in some cases. The ion-exchangeable layered inorganic compound may contain a natural substance and a synthetic substance.

Specific examples of the ion-exchangeable layered inorganic compound include clay minerals. Concrete examples thereof include kaolinite, dickite, halloysite, nacrite, isinglass, serpentine, montmorillonite, cristobalite, feldspar, zeolite, molecular sieve, mica, smectite, vermiculite, chlorite, talc, allophane, imogolite, hisingerite, pyrophyllite, palygorskite, hydrotalcite and the like.

The clay minerals may be in the form of clay, such as kaolin, bentonite, acid clay, activated clay, kibushi clay, gaerome clay and the like.

Other specific examples of the ion-exchangeable layered inorganic compound include a crystalline acid salt of a polyvalent metal, such as α—Zr(HAsO₄)₂.H₂O, α—Zr(HPO₄)₂, α—Zr(KPO₄)₂.3H₂O, α—Ti(HPO₄)₂, α—Ti(HAsO₄)₂.H₂O, α—Sn(HPO₄)₂.H₂O, γ—Zr(HPO₄)₂, γ—Ti(HPO₄)₂, γ—Ti(NH₄PO₄)₂.H₂O and the like.

Among the ion-exchangeable layered inorganic compounds, a compound containing aluminum and (magnesium and/or iron) as constitutional elements is preferred, and acid clay and hydrotalcite are particularly preferred.

The method for bringing the ion-exchangeable layered inorganic compound and the norbornene compound addition polymer into contact with each other in an organic solvent is not particularly limited, and examples thereof include a method, in which the ion-exchangeable layered inorganic compound is added to a solution of the norbornene addition polymer in the organic solvent, followed by stirring, and insoluble components are removed by filtration to recover a solution of the norbornene compound addition polymer, a method, in which a solution of the norbornene compound addition polymer in the organic solvent is passed through a container filled with the ion-exchangeable layered inorganic compound, and the like.

The organic solvent used for preparing the norbornene compound addition polymer organic solvent solution is not particularly limited as far as it dissolves the norbornene compound addition polymer.

Specific examples thereof include an aliphatic hydrocarbon, such as pentane, hexane, heptane or the like; an alicyclic hydrocarbon, such as cyclopentane, cyclohexane, methylcyclohexane, dimethylcyclohexane, trimethylcyclohexane, ethylcyclohexane, diethylcyclohexane, decahydronaphthalene, bicycloheptane, tricyclodecane, hexahydroindene, cyclooctane or the like; an aromatic hydrocarbon, such as benzene, toluene, xylene or the like; a nitrogen-containing solvent, such as nitromethane, nitrobenzene, acetonitrile or the like; an ether compound, such as diethyl ether, tetrahydrofuran or the like; a halogen solvent, such as dichloromethane, chloroform, chlorobenzene, dichlorobenzene or the like; and the like.

Among these, an aromatic hydrocarbon, an aliphatic hydrocarbon, an alicyclic hydrocarbon, an ether compound and a halogen solvent are preferred.

The concentration of the norbornene compound addition polymer in the norbornene compound addition polymer organic solvent solution when the solution is brought into contact with the ion-exchangeable layered inorganic compound is not particularly limited, and is preferably from 0.1 to 50% by weight, more preferably from 0.2 to 45% by weight, and particularly preferably from 0.5 to 40% by weight. In the case where the concentration of the polymer is within the range, the solution has an appropriate viscosity and is easily handleable thereby assuring good productivity on removing impurities.

Preferably, the ion-exchangeable layered inorganic compound and the norbornene compound addition polymer are brought into contact with each other in the organic solvent under a hydrogen atmosphere, since the polymerization catalyst residue forms a hydride compound to facilitate a reaction with the ion-exchangeable layered inorganic compound, whereby the removal efficiency of the polymerization catalyst residue is enhanced.

The temperature, at which the ion-exchangeable layered inorganic compound and the norbornene compound addition polymer are brought into contact with each other, is not particularly limited, and is generally from −30° C. to +300° C., and preferably from 0° C. to 250° C. The contact time is not particularly limited, and is from 1 minute to 200 hours.

The amount of the ion-exchangeable layered inorganic compound brought into contact with the solution of the norbornene compound addition polymer varies depending on the contact temperature and the contact time, and is generally from 0.1% to 500%, and preferably from 0.2% to 200%, by weight, based on the norbornene compound addition polymer.

### (Molded Article)

The norbornene compound addition polymer of the invention can be molded into a molded article, such as an optical member, an electric insulating member, an electric or electronic member, an electronic member sealant, medical equipment, a packaging material and the like.

The form of the molded article of the invention is not particularly limited, and representative examples thereof include a sheet and a film.

The norbornene compound addition polymer of the invention may be solely formed into a molded article and may be used in combination at an arbitrary ratio with other transparent resin, such as a cyclic olefin addition polymer, a hydrogenated cyclic olefin ring-opening polymer, an addition copolymer of an α-olefin with a cyclic olefin, a crystalline α-olefin polymer, a rubbery copolymer of ethylene with an α-olefin having 3 or more carbon atoms, a hydrogenated butadiene polymer, a hydrogenated butadiene-styrene block copolymer, a hydrogenated isoprene polymer and the like.

Upon molding a molded article from the norbornene compound addition polymer of the invention, various kinds of additives may be added if circumstances require.

Examples of the additives include a filler, an antioxidant, a fluorescent material, an ultraviolet ray absorbent, an antistatic agent, a light stabilizer, a near infrared ray absorbent, a colorant, such as a dye, a pigment and the like, a lubricant, a plasticizer, a flame retardant, a crosslinking agent and the like.

Examples of the filler include an oxide of a metal, such as silicon, titanium, aluminum, zirconium and the like.

Examples of the antioxidant include a phenolic antioxidant, a lactone antioxidant, a phosphorous antioxidant, a thioether antioxidant and the like.

The fluorescent material is excited when irradiated with light to emit light having a wavelength longer than the excitation wavelength. When an optical devise is sealed, for example, it is irradiated with light, emitted by the optical device, having a wavelength within the range of from the blue region to the ultraviolet region thereby to emit light having a wavelength within the visible region when.

The method for incorporating the additives is not particularly limited.

The molded article comprised of the norbornene compound addition polymer of the invention can be obtained by a known molding method.

### (Sheet or Film)

The norbornene compound addition polymer of the invention is easily dissolved in an organic solvent. Accordingly, the polymer can be formed into a sheet or film by a solution cast method, in which the organic solvent solution of the polymer is applied or cast on a steel belt, a carrier film or the like, followed by a drying step to give a molded article.

The norbornene compound addition polymer of the invention can also be formed into a sheet or film containing a woven cloth or a nonwoven cloth, by impregnating a woven cloth, such as a glass cloth or the like, or a nonwoven cloth with an organic solvent solution of the polymer, followed by drying.

The norbornene compound addition polymer of the invention can also be formed into a sheet or film by swelling the norbornene compound addition polymer of the invention with an organic solvent, followed by molding and processing the polymer into a sheet or film with an extruder while the solvent is evaporated.

The norbornene compound addition polymer of the invention can also be molded by casting an organic solvent solution of the polymer into a mold, followed by evaporation of the solvent. The polymer can also be molded by applying an organic solvent solution thereof to a particular member or substrate, followed by evaporation of the solvent.

A sheet or film may also be formed from a polymer blend composition, which is formed by incorporating the norbornene compound addition polymer of the invention with other thermoplastic resin, by a melt extrusion method using a melt extruder or the like.

The thickness of the sheet or film may be selected depending on purposes and is generally from 1 to 1,000 μm, and preferably from 2 to 500 μm. In the case where the thickness is within the range above, the period of time required for forming the sheet or film can be shortened, and the resulting sheet or film is excellent in strength.

The sheet or film formed of the norbornene compound addition polymer of the invention has a light transmittance of 70% or more, preferably 80% or more, and more preferably 85% or more, and thus can be favorably used as a substrate for a color filter.

The norbornene compound addition polymer of the invention has high heat resistance and has a small content of a Group 10 transition metal atom, a halogen atom, a phosphorus atom, an aluminum atom, a boron atom and a sulfur atom, and therefore, the sheet or film does not suffer from deformation, yellowing and crack formation even at a high film forming temperature of from 200 to 300° C.

### (Transparent Electroconductive Film-Laminated Sheet or Film)

The sheet or film formed of the norbornene compound addition polymer of the invention may have a transparent electroconductive film laminated thereon.

Specifically, a transparent electroconductive film is laminated by using an inorganic material, such as an inorganic oxide, an inorganic nitride, an inorganic sulfide and the like, e.g., indium tin oxide (ITO), aluminum oxide, silicon oxide, titanium oxide, zinc oxide, tungsten oxide, aluminum nitride, silicon nitride, titanium nitride, cadmium sulfide, zinc sulfide, zinc selenide and the like, by a vacuum film forming method, such as a sputtering method, a vapor deposition method, a CVD method and the like.

The thickness of the transparent electroconductive film can be appropriately selected from a range of from 50 to 4,000 Å.

The transparent electroconductive film-laminated sheet or film of the invention has a light transmittance of 70% or more, preferably 80% or more, and more preferably 85% or more, and thus can be favorably used as a substrate for a color filter.

In the transparent electroconductive film-laminated sheet or film of the invention, an adhesive layer may be provided between the sheet or film formed of the norbornene compound addition polymer and the transparent electroconductive film for enhancing the smoothness of the sheet or film and the adhesiveness thereof to the transparent electroconductive film. The adhesive layer can be obtained by applying resin varnish, followed by drying for solvent removal. For this purpose, varnish containing a solid resin, which forms a film after solvent removal is preferably used from the standpoint of uniform application. Specific examples of the resin therefor include a photo-curable resin, such as an acrylic prepolymer, e.g., epoxy diacrylate, urethane diacrylate, polyester diacrylate and the like; a thermosetting resin, such as an o-cresol novolac-type resin and a bisphenol-type resin, a urethane resin, an acrylic resin, a urea resin, a melamine resin and an unsaturated polyester resin; an electron beam-curable resin; and the like. Among these, a photo-curable resin is preferred from the standpoint of productivity and cost.

Examples of the method for forming the cured resin film on a substrate include a gravure coating method, a reverse roll coating method, a kiss roll coating method and the like, any of which may be used.

The transparent electroconductive film laminated sheet or film of the invention may have a gas barrier layer on the opposite side to the transparent electroconductive film. The gas barrier layer may be formed of an inorganic material or an organic material. Examples of the usable inorganic material include silicon oxide, aluminum oxide, indium oxide and the like, and examples of the usable organic material include polyvinyl alcohol, an ethylene-vinyl alcohol copolymer, polyamide and the like.

The thickness of the gas barrier layer is desirably from 100 to 2,000 Å for the inorganic material and from 500 to 10,000 Å for the organic material.

These inorganic materials can be formed into a film by a known method, such as a sputtering method, an ion plating method, a resistance heating method, a CVD method and the like. In the case of the organic material, a film can be formed by dissolving the material in a solvent and is applied by the application method mentioned above, followed by drying.

An adhesive layer may be provided between the sheet or film and the gas barrier layer.

A protective coating layer may be further laminated on the gas barrier layer for protecting the same. The protective coating is preferably formed in the same manner as the adhesive layer.

### (Color Filter)

A color filter can be obtained by laminating a color filter layer on the substrate for a color filter of the invention. The laminating method includes known methods, such as a pigment dispersion method, a dyeing method, an electrodeposition method, a printing method, a transferring method and the like.

In the pigment dispersion method, for example, a black matrix is formed on the substrate for a color filter of the invention with a metallic light-shielding film of a chromium compound, such as metallic chromium, chromium oxide or chromium nitride, a nickel-tungsten alloy and the like, by a sputtering method or a vacuum deposition method, and then a photosensitive resin composition (color resist) having a red pigment dispersed therein is applied on the entire surface thereof by a spin coating method, a wire bar coating method, a flow coating method, a die coating method, a roll coating method, a spray coating method or the like, which is then exposed to light through a mask and developed after exposure to form red pixels. Blue and green pixels are formed by application, exposure and development in the same manners. Thus, pixels of three colors are formed. The order of the formation of pixels of three colors is not particularly determined and may be arbitrarily selected. In the case where the black matrix part among the pixels remains as dents, a protective film may be formed for smoothening the surface by covering it with a transparent resin, such as an epoxy resin, an acrylic resin and the like. The pigment dispersion method may be employed when the black matrix is formed. Specifically, a photosensitive resin (black resist) having a black pigment dispersed therein may be applied, exposed and developed.

As the constitutional components of the color resists and the black resist and the applying, exposing and developing methods, the constitutional components and the methods disclosed, for example, in JP-A-2004-51651, JP-A-2004-347831 and the like may be employed. As for the printing method, known methods, for example, ink and printing methods disclosed in JP-A-6-347637, JP-A-11-326622 and JP-A-2004-333971 may be used.

The norbornene compound addition polymer of the invention has high resistance to chemicals, such as a resist, ink, a developing solution and the like, and thus the substrate does not suffer from deformation or crack formation in the color filter laminating step.

The transparent substrate and the substrate having formed a black matrix thereon may be subjected to a corona discharge treatment, an ozone treatment, a thin film formation treatment with a silane coupling agent or various resins, such as a urethane resin, for improving the surface properties, such as adhesiveness and the like, if circumstances require. In the case where the thin film formation treatment with various resins is carried out, the thickness is generally within a range of from 0.01 to 10 μm, and preferably in a range of from 0.05 to 5 μm.

The color filter of the invention can be used as a color filter of a liquid crystal display device. A color filter produced by using the substrate of the invention can be used as a part of members of a color display, a liquid crystal display device and the like.

### (Optical Member)

The sheet or film comprised of the norbornene compound addition copolymer of the invention can be favorably used as, in addition to a substrate for a color filter, an optical member, such as a light guide plate, a protective film, a polarizing film, a phase retardation film, a touch-sensitive panel, a substrate for a transparent electrode, an optical recording substrate of CD, MD, DVD and the like, a substrate for a TFT device, a substrate for a liquid crystal display device, a substrate for an organic EL display device, a light wave guide for optical transmission, an optical lens, a sealant and the like.

The polarizing film comprises a sheet or film comprised of the norbornene compound addition copolymer of the invention and, laminated on at least one surface thereof, a polarizing film via or not via an adhesive layer.

In the phase retardation film, the sheet or film comprised of the norbornene compound addition copolymer of the invention is preferably stretched in at least one direction at a stretching ratio of from 1.1 to 4 times.

The molded article comprised of the norbornene compound addition polymer of the invention can be used as, in addition to an optical member, an electric insulating member, an electric or electronic member, an electronic member sealant, medical equipment and a packaging material.

### (Electric Insulating Member)

As the molded article comprised of the norbornene compound addition polymer of the invention is excellent in heat resistance and has a small content of a Group 10 transition metal atom, a halogen atom and a phosphorus atom and therefore does not suffer from heat deformation in a soldering step or deterioration in mechanical properties due to heat deterioration, it can be suitably used as an electric insulating member.

Examples of the electric insulating member include a covering material of a wire and a cable, an insulating material for office equipment, such as a computer, a printer, a duplicator and the like, an insulating member for a flexible printed circuit board, and the like. In particular, the electric insulating member in a form of a sheet or film is favorably used as a flexible printed circuit board.

### (Electric and Electronic Member)

As the electric and electronic member, the polymer is used as a container, a tray, a carrier tape, a separation film, a rinsing vessel, a pipe, a tube and the like, and also include a semiconductor device, a sealant for an optical device (such as a light emitting diode and the like), a sealant for an integrated circuit, a overcoating material and the like.

### (Electronic Member Sealant)

The norbornene compound addition polymer of the invention is excellent in heat resistance, low water-absorption, transparency and electric properties, and therefore is useful as a sealant for an electronic member. Examples of the electronic member include a part of an integrated circuit containing a semiconductor chip, such as CPU, DRAM and the like; a semiconductor member, such as a diode, a transistor, a light emitting device (such as LED and the like) and the like; and an ordinary electronic member, such as a resistor, a capacitor, an inductor, a ceramic filter, a thermistor and the like. Among these, the polymer is preferred as an LED device sealant for a blue LED device, an ultraviolet LED device, a white LED device and the like, and in particular as a sealant for a surface mount type LED of these devices.

A method of sealing an electronic member can be carried out by attaching an organic solvent solution of the norbornene compound addition polymer of the invention to an electronic member to be sealed, followed by solvent removal by evaporation. At this time, a transfer molding method, a potting method, a coating method or the like, as conventional sealing methods, may be employed. In the case where a transfer molding method is employed, a solid constituent of the norbornene compound addition polymer containing a small amount of an organic solvent is softened by heating, and then molded by injecting into a mold having an electronic member mounted thereto, followed by removal of the small amount of the solvent by evaporation. In the case where a potting method is used, a solution of the norbornene compound addition polymer having a high viscosity is charged in an electronic member to be sealed, followed by drying. In the case where a coating method is used, a solution of the norbornene compound addition polymer is applied on an electronic member to be sealed, particularly an electronic substrate or the like, by a roll coating method, a curtain coating method, a screen printing method, a spin coating method, a dipping method or the like, followed by removal of the solvent by evaporation.

### (Medical Equipment)

As medical equipment, the polymer is used as a container for a medicine, an ampoule, a syringe, a bag for an infusion solution, a sample container, a test tube, a blood sampling tube, a sterile container, a pipe, a tube and the like.

### EXAMPLE

The invention will be described more specifically with reference to polymerization examples, examples and comparative examples below. The invention is not limited to the examples below. All parts and percents in the examples are by weight unless otherwise indicated.

The tests and evaluations in the examples and comparative examples were carried out in the following manners.

### (1) Weight Average Molecular Weight (Mw) and Number Average Molecular Weight (Mn) of Polymer

The values are measured as polystyrene equivalent values by gel permeation chromatography (GPC) with tetrahydrofuran or chloroform as a solvent.

### (2) Copolymerization Ratio of Polymer

The value is measured by ¹H-NMR.

(3) Amounts of Group 10 Transition Metal Atom in the Periodic Table, Phosphorus Atom, Aluminum Atom and Boron Atom contained in Polymer

The values are obtained by the ICP-AES method.

(4) Amounts of Halogen Atom and Sulfur Atom contained in Polymer

The polymer is combusted and then formed into a halogen ion or sulfur ion aqueous solution, and the values are obtained by column chromatography.

### (5) Film Strength (Presence of Cracking on Folding)

A film having a thickness of 100 μm prepared from a toluene solution is allowed to stand in an air atmosphere at 200° C. for 5 minutes, and the film is folded down the middle. The film strength is evaluated by the presence of cracking at the folded part.

### (6) Glass Transition Temperature (Tg)

The value is measured as the flexion point of the storage elastic modulus E′ by dynamic viscoelasticity measurement. The dynamic viscoelasticity measurement is carried out by DMS6100 (produced by Seiko Instruments, Inc.), and the temperature at the flexion point of the storage elastic modulus E′ is measured at a measuring frequency of 10 Hz, a temperature-increasing rate of 5° C. per minute, a vibration mode of a single waveform and a vibration amplitude of 5.0 μm.

### Polymerization Example 1

### Preparation of Norbornene-Ethylidenenorbornene Copolymer

0.77 part of (allyl)palladium (tricyclohexylphosphine)chloride and 1.14 parts of lithium tetrakis(pentafluorophenyl)borate were placed in a glass reactor having the inside thereof purged with nitrogen, and 2 parts of toluene was subsequently added thereto to give a catalyst liquid.

1,645 parts of bicyclo[2.2.1]hept-2-ene, 901 parts of 5-ethylidenebicyclo[2.2.1]hept-2-ene, 261 parts of styrene as a molecular weight controlling agent, and 5,941 parts of toluene as a polymerization solvent were then charged in a pressure-proof glass reactor equipped with a stirrer having the inside thereof purged with nitrogen, to which the catalyst liquid was added to initiate polymerization. After the reaction at 60° C. for 3 hours, the polymerization reaction liquid was poured in a large amount of methanol to completely precipitate a polymer, which was filtered and rinsed, followed by drying under reduced pressure at 50° C. for 18 hours, to give 2,278 parts of a polymer (1).

The resulting polymer (1) was soluble in toluene, chloroform and the like. The polymer (1) had Mw of 608,000 and Mn of 196,000, and the compositional ratio of bicyclo[2.2.1]hept-2-ene/5-ethylidenebicyclo[2.2.1]hept-2-ene in the polymer (1) was 70/30 (mol/mol). Tg was 287° C.

### Polymerization Example 2

### Preparation of Norbornene-Triethoxysilylnorbornene Copolymer

0.15 part of (allyl)palladium (tricyclohexylphosphine)chloride and 0.23 part of lithium tetrakis(pentafluorophenyl)borate were placed in a glass reactor having the inside thereof purged with nitrogen, and 1 part of toluene was subsequently added thereto to give a catalyst liquid.

376 parts of bicyclo[2.2.1]hept-2-ene, 256 parts of 5-triethoxysilylbicyclo[2.2.1]hept-2-ene, 156 parts of styrene as a molecular weight controlling agent, and 1,475 parts of toluene as a polymerization solvent were then charged in a pressure-proof glass reactor equipped with a stirrer having the inside thereof purged with nitrogen, to which the catalyst liquid was added to initiate polymerization. After the reaction at 60° C. for 3 hours, the polymerization reaction liquid was poured in a large amount of methanol to completely precipitate a polymer, which was filtered and rinsed, followed by drying under reduced pressure at 50° C. for 18 hours, to give 521 parts of a polymer (2).

The resulting polymer (2) was soluble in toluene, chloroform and the like. The polymer (2) had Mw of 781,000 and Mn of 245,000, and the compositional ratio of bicyclo[2.2.1]hept-2-ene/5-triethoxysilylbicyclo[2.2.1]hept-2-ene in the polymer (2) was 93/7 (mol/mol). Tg was 380° C.

### Example 1

10 parts of the polymer (1) obtained in Polymerization Example 1 was dissolved in 200 parts of toluene. The resulting polymer solution (1) was slightly colored yellow. 5 parts of hydrotalcite (“Kyoward 500 SN”, a trade name, produced by Kyowa Chemical Industry Co., Ltd.) was added thereto, and the mixture was introduced to an autoclave equipped with a stirrer, followed by stirring under a condition of a hydrogen pressure of 1 MPa, 200° C. and 5 hours. The polymer solution (1) was suction-filtered to remove hydrotalcite. The filtrate was colorless and transparent.

The amounts of a palladium atom, a halogen atom, a phosphorus atom, an aluminum atom, a boron atom and a sulfur atom in the filtrate were as shown in Table 1 in terms of proportions to the polymer (1).

TABLE 1

| | | Exam- | Comparative | Exam- | Comparative |
|---|---|---|---|---|---|
| | | ple 1 | Example 1 | ple 2 | Example 2 |
| Polymer | | (1) | (1) | (2) | (2) |
| Purification treatment | | done | none | done | none |
| Catalyst | Palladium | 1.3 | 52 | 6.5 | 49 |
| residue | Halogen | 2.1 | 139 | 2.3 | 36 |
| in polymer | Phosphorus | 0.5 | 12 | 0.6 | 9 |
| (ppm by | Aluminum | 0 | 0 | 0 | 0 |
| weight) | Boron | 0.5 | 5 | 0.5 | 3 |
| | Sulfur | 0 | 0 | 0 | 0 |
| | Total | 4.4 | 208 | 9.9 | 97 |

### Example 2

10 parts of the polymer (2) obtained in Polymerization Example 2 was dissolved in 200 parts of toluene. The resulting polymer solution (2) was slightly colored yellow. 5 parts of acid clay (produced by Wako Pure Chemical Industries, Ltd.) was added thereto, and the mixture was introduced to a separable flask equipped with a stirrer, followed by purge with nitrogen and then stirring under a condition of ordinary pressure, 120° C. and hours. The polymer solution (2) was suction-filtered to remove acid clay. The filtrate was colorless and transparent.

The amounts of a palladium atom, a halogen atom, a phosphorus atom, an aluminum atom, a boron atom and a sulfur atom in the filtrate were as shown in Table 1 in terms of proportions to the polymer (2).

### Comparative Example 1

The polymer (1) obtained in Polymerization Example 1 with no purification treatment was evaluated for amounts of a palladium atom, a halogen atom, a phosphorus atom, an aluminum atom, a boron atom and a sulfur atom. The results are shown in Table 1.

### Comparative Example 2

The polymer (2) obtained in Polymerization Example 2 with no purification treatment was evaluated for amounts of a palladium atom, a halogen atom, a phosphorus atom, an aluminum atom, a boron atom and a sulfur atom. The results are shown in Table 1.

### Example 3

The polymer solution (1) obtained in Example 1 were concentrated to 10%, and subsequently cast on a flat sheet of a tetrafluoroethylene polymer, and toluene was removed by evaporation at room temperature for 24 hours under air stream, followed by vacuum drying at 80° C. for 24 hours, to give a film (1) having a thickness of 100 μm.

The resulting film (1) was allowed to stand in an air atmosphere at 200° C. for 5 minutes, and the film was evaluated for transparency and film strength (presence of cracking on folding). The results are shown in Table 2.

TABLE 2

| | | Comparative | | Comparative |
|---|---|---|---|---|
| | Example 3 | Example 3 | Example 4 | Example 4 |
| Polymer | (1) | (1) | (2) | (2) |
| solution | | | | |
| Cast film | (1) | (C1) | (2) | (C2) |
| Transparency | colorless and | yellowed | colorless and | yellowed |
| | transparent | | transparent | |
| Film strength | none | present | none | present |
| (presence of | | | | |
| cracking on | | | | |
| folding) | | | | |

### Example 4

A film (2) was obtained in the same manner as in Example 3 except that the polymer solution (2) obtained in Example 2 was used, and the film was evaluated for transparency and film strength (presence of cracking on folding). The results are shown in Table 2.

### Comparative Example 3

A cast film (C1) was prepared in the same manner as in Example 3 except that the polymer solution (1) obtained by dissolving, in toluene, the polymer (1) obtained in Polymerization Example 1 was used without a purification treatment, and the film was allowed to stand in an air atmosphere at 200° C. for 5 minutes. The cast film (C1) was evaluated for transparency and film strength (presence of cracking on folding). The results are shown in Table 2.

### Comparative Example 4

A cast film (C2) was prepared in the same manner as in Comparative Example 1 except that the polymer (2) obtained in Polymerization Example 2 was used instead of the polymer (1) obtained in Polymerization Example 1.

The resulting film (C2) was allowed to stand in an air atmosphere at 200° C. for 5 minutes, and the film was evaluated for transparency and film strength (presence of cracking on folding). The results are shown in Table 2.

It is understood from the results shown in Tables 1 and 2 that in the case where the purification treatment is not carried out after polymerization, the total amount of a group 10 transition metal atom in the periodic table, a halogen atom, a phosphorus atom, an aluminum atom, a boron atom and a sulfur atom in the polymer is as large as 208 ppm by weight (Comparative Example 1) and 97 ppm by weight (Comparative Example 2), and the films obtained by molding them are yellowed after the heat treatment and mechanical strength of the film is deteriorated (Comparative Examples 3 and 4). On the other hand, it is also understood that the norbornene compound addition polymers of the invention have a total amount of a group 10 transition metal atom in the periodic table, a halogen atom, a phosphorus atom, an aluminum atom, a boron atom and a sulfur atom of 50 ppm by weight or less, and the films as molded articles obtained therefrom are excellent in transparency after the heat treatment and is also excellent in mechanical strength.

### Example 5

A polyvinyl alcohol film having a polymerization degree of 2,400 and a thickness of 75 μm was subjected to a dyeing treatment by immersion in a dyeing bath having iodine and potassium iodide incorporated thereinto at 40° C., and then subjected to a stretching treatment and a crosslinking treatment in an acidic bath having boric acid and potassium iodide incorporated thereinto at 60° C. to a total stretching ratio of 5.3 times. The film was rinsed with water and then dried at 40° C. to give a polarizing film having a thickness of 28 μm.

A sheet of the norbornene compound addition polymer film (1) having a thickness of 100 μm obtained in Example 3 was adhered to each of both surfaces of the resulting polarizing film via an acrylic adhesive (“dp-8005 Clear”, a trade name, produced by Sumitomo 3M, Ltd.) to give a polarizing film.

The resulting polarizing film was allowed to stand in an air atmosphere at 200° C. for 5 minutes, and the film was evaluated for transparency and film strength (presence of cracking on folding). The film did not suffer from yellowing and cracking upon folding.

### Example 6

The norbornene compound addition polymer film (1) having a thickness of 100 μm obtained in Example 3 was stretched unidirectionally at a stretching ratio of 1.5 times in a nitrogen atmosphere at 285° C. to give a phase retardation film.

The resulting phase retardation film was allowed to stand in an air atmosphere at 200° C. for 5 minutes, and the film was evaluated for transparency and film strength (presence of cracking on folding). The film was colorless and transparent and did not suffer from cracking upon folding.

1. A norbornene compound addition polymer comprising, as an essential component, a repeating structural unit derived from a norbornene compound monomer having a substituent group that has a total content of a group 10 transition metal atom in the Periodic Table, a halogen atom, a phosphorus atom, an aluminum atom, a boron atom and a sulfur atom of 50 ppm by weight or less.

2. The norbornene compound addition polymer according to claim 1, wherein a content of a halogen atom is 30 ppm by weight or less.

3. The norbornene compound addition polymer according to claim 1 or 2, wherein a content of a phosphorus atom is 1 ppm by weight or less.

4. The norbornene compound addition polymer according to claim 1, wherein the norbornene compound addition polymer is one polymerized using a catalyst comprising, as essential components, a Group 10 transition metal atom in the Periodic Table, a halogen atom and a phosphorus atom.

5. The norbornene compound addition polymer according to claim 4, wherein the Group 10 transition metal atom in the Periodic Table is palladium.

6. A process for producing the norbornene compound addition polymer according to claim 1, comprising a step of bringing a norbornene compound addition polymer comprising, as an essential component, a repeating structural unit derived from a norbornene compound monomer having a substituent group, into contact with an ion-exchangeable layered inorganic compound in an organic solvent.

7. The process for producing the norbornene compound addition polymer according to claim 6, wherein the norbornene compound addition polymer comprising, as an essential component, a repeating structural unit derived from a norbornene compound monomer having a substituent group is brought into contact with the ion-exchangeable layered inorganic compound in the organic solvent under a hydrogen atmosphere.

8. The process for producing the norbornene compound addition polymer according to claim 6 or 7, wherein the ion-exchangeable layered inorganic compound is one containing, as constitutional elements, aluminum and (magnesium and/or iron).

9. A molded article comprised of the norbornene compound addition polymer according to claim 1.

10. The molded article according to claim 9, wherein the molded article has a form of a sheet or film.

11. The molded article according to claim 10, wherein the molded article has a transparent electroconductive film laminated thereon.

12. A substrate for a color filter that is comprised of the norbornene compound addition polymer according to claim 1.

13. The substrate for a color filter according to claim 12 that has a form of a sheet or film.

14. A color filter comprised of the substrate for a color filter according to claim 12 or 13.

15. An optical member, an electric insulating member, an electric or electronic member, an electronic member sealant, medical equipment or a packaging material comprised of the molded article according to claim 9.

16. A substrate for a liquid crystal display device that is comprised of a sheet or film comprised of the norbornene compound addition polymer according to claim 1 having or not having a transparent electroconductive film laminated thereon.

17. A polarizing film comprised of a sheet or film that is comprised of the norbornene compound addition polymer according to claim 1 having or not having a transparent electroconductive film laminated thereon, and has a polarizing film laminated on at least one surface thereof via or not via an adhesive layer.

18. A phase retardation film comprised of a sheet or film that is comprised of the norbornene compound addition polymer according to claim 1 having or not having a transparent electroconductive film laminated thereon and has been stretched in at least one direction at a stretching ratio of from 1.1 to 4 times.
